(19) United States
(12) Patent Application Publication
(10) Pub. No.: US 2016/0155147 A1
(43) Pub. Date: Jun. 2, 2016

(54) SYSTEM AND METHOD FOR GENERATING BIDS FOR KEYWORDS

(71) Applicant: THE SEARCH AGENCY, Los Angeles, CA (US)

(72) Inventors: Carl A. Dunham, Wakefield, RI (US); Donald Ross Gardner, III, North Kingstown, RI (US); Bradd Elden Libby, Sarpsborg (NO)

(21) Appl. No.: 15/016,480

(22) Filed: Feb. 5, 2016

Related U.S. Application Data
(63) Continuation of application No. 13/362,668, filed on Jan. 31, 2012.

(51) Int. Cl. G06Q 30/02

(52) U.S. Cl. CPC G06Q 30/0256; G06Q 30/0275; G06Q 30/0277

(57) ABSTRACT

A method for generating bids for a group of keywords includes accessing, over a computer network, budget data and historical spend data for at least two groups of keywords. The method also includes determining a baseline portion of a budget to be allocated to a first group of keywords. The method also includes predicting, with reference to the historical spend data and the historical budget allocation data, an unspent amount. The method also includes calculating, based upon at least one adjustable allocation parameter, a first portion of the unspent amount to be allocated. The method also includes allocating the baseline portion and the first portion of the unspent amount to the first group of keywords. The method also includes allocating a second portion of the unspent amount to the second group of keywords. The method also includes generating bids for the first group of keywords.

### RELATED APPLICATIONS

This application claims the benefit under 35 U.S.C. §120 as a continuation of U.S. application Ser. No. 13/362,668, titled “SYSTEM AND METHOD FOR ALLOCATING UNSPENT ADVERTISING BUDGET AND GENERATING KEYWORD BIDS,” filed on Jan. 31, 2012, which is herein incorporated by reference in its entirety.

### FIELD OF THE INVENTION

The present invention is directed to online advertising.

### DISCUSSION OF RELATED ART

In addition to so-called “natural” search results, many search engines, such as those offered by Google, Inc. of Mountain View, Calif. and the Microsoft Corporation, of Redmond, Wash., among others, present users with “sponsored” (i.e., paid) search results in response to a keyword search. Typically, these search engines conduct keyword auctions in which an online marketer may bid a certain amount to associate its advertisement with one or more keywords. These auctions are continuously conducted, and a marketer can adjust its bid amounts as often as desired.

When a search on one of the bid-upon keywords is performed, the marketer's advertisements may be displayed alongside other advertisements associated with the keyword. The relative position and prominence of the advertisements may be dictated to some degree by the amount of the marketer's bid and/or the quality of the advertisement; a higher bid for an advertisement with a higher quality score may command a more prominent position.

The marketer may pay the full bid amount each time the advertisement is displayed, or it may pay some other amount. For example, the Google search engine employs a variant of the next-price or “Vickrey” sealed-bid auction model. In this scenario, the marketer who places the highest bid (taking into account the quality of the associated advertisement) wins the auction, and pays the next-highest bid amount plus some defined increment (e.g., $0.01) to have its advertisement displayed in the most desirable position relative to the search results. Likewise, the second-highest bidder pays the defined increment over the third-highest bid amount to have its advertisement displayed in the second-most desirable position, and so on.

Marketers may set hourly, daily, weekly, monthly, and/or annual budgets for keyword groups. Bids will typically be generated and placed for those keyword groups until the budget for a particular time period is spent. In some circumstances, the entire budget may not be spent during the time period. For example, a cost-per-click (CPC) advertisement may not generate enough clicks to spend the entire budget.

Marketers can manage keyword spend budgets on a number of levels. A monthly budget may be set for an entire account, to ensure the amount spent is kept within a controlled amount. Some search engine advertising platforms, such as the AdWords program offered by Google, also provide daily campaign-level budget limits, so marketers can set budgets on a campaign level. In the case of the AdWords implementation of campaign level daily budgets, the actual campaign spend may exceed the amount specified on a given day; which overspend may be compensated for by less spending on the campaign during some other period in the month.

There are a number of complexities associated with budgeting. Budgeting represents an additional constraint when allocating money to keywords and calculating keyword bids, and having a budget that is constrained by a time period introduces other concerns. For instance, a marketer could spend their entire budget on the first day of the month, but in order to do so, would likely be spending it on a few relatively high-CPC keywords and may be getting fewer total clicks than are possible if the budget were spent on lower-CPC keywords spread out over a longer period. Additionally, some marketers may attribute some value to impressions. For example, rather than spending an entire budget in a few days to appear in a top results position, it may be more desirable to a marketer for its advertisement to appear more frequently, but in a lower position, in response to searches for important terms (such as brand names). Similarly, there may be a desire to pay a higher cost to appear in response to search queries containing the marketer's brand name. This goal, often pursued without regard to ROI expectations, is sometimes referred to as “claiming your brand in the search results.”

### SUMMARY OF THE INVENTION

Though bids may be generated for a set of keywords, the actual amount spent on advertising for those bids may differ from the generated bid amounts. For example, the actual amount spent may be less than the generated bid amounts, meaning that a portion of the advertising budget for those bids may remain unspent. Thus there is a need for a system and method for predicting what portion of a bid will remain unspent, and allocating a portion of that amount to another keyword.

Though advertising systems generally guard against overspending, they do not prevent underspending. Therefore, marketers often manually raise bids on keywords, or re-activate previously deactivated keywords or campaigns towards the end of the month, in an attempt to spend all of their budget before time runs out

According to one aspect, a method for generating bids for a group of keywords is provided. The method comprises acts of accessing, over a computer network, budget data and historical spend data for at least two groups of keywords, and determining a baseline portion of a budget to be allocated to a first group of keywords. The method further comprises acts of predicting, with reference to the historical spend data and the budget data, an unspent amount; calculating, based upon at least one adjustable allocation parameter, a first portion of the unspent amount to be allocated, and allocating the baseline portion and the first portion of the unspent amount to the first group of keywords. The method further comprises acts of allocating a second portion of the unspent amount to the second group of keywords, and generating bids for the first group of keywords.

According to one embodiment, the method further comprises an act of providing for a user of a computer system to adjust the adjustable allocation parameter.

According to another embodiment, the at least one allocation parameter is accessed over the computer network. According to another embodiment, the at least one allocation parameter is a percentage. According to a further embodiment, the at least one allocation parameter varies based upon the day of the month. According to another embodiment, the first portion of the unspent amount varies based upon the aggregate unspent budget for the at least two groups of keywords. According to still another embodiment, the portion of the unspent amount varies based on a relationship between a first average cost-per-click amount of the first group of keywords and a second average cost-per-click amount of at least one other group of keywords. According to yet another embodiment, the at least one allocation parameter is adjusted based upon at least one spending multiplier.

According to another embodiment, the at least one allocation parameter is determined by a rule-based scheme. According to a further embodiment, the method further comprises acts of calculating at least one metric for the first keyword group and at least one other keyword group, ranking the first keyword group and the at least one other keyword group relative to each other according to the at least one metric, and determining an allocation parameter for the first keyword group based on its relative ranking. According to a still further embodiment, the at least one metric is a cost metric, and the first keyword group and the at least one other keyword group are ranked in ascending order based upon the at least one metric. According to a further embodiment, the cost metric is a cost-per-click metric. According to yet another embodiment, the cost metric is a cost-per-action metric. According to a further embodiment, the cost-per-action metric is a cost-per-conversion metric.

According to another embodiment, the at least one metric is a budget metric, and the first keyword group and the at least one other keyword group are ranked in descending order based upon the budget metric. According to a further embodiment, the budget metric is a budget amount metric. According to another embodiment, the budget metric is a percentage of a previously allocated budget spent in a time period.

According to another embodiment, the at least one metric is a multivariate score, and the first keyword group and the at least one other keyword group are ranked in order based upon the multivariate score.

According to another embodiment, the act of determining a baseline portion of a budget to be allocated to a first group of keywords comprises an act of determining an unspent amount previously allocated to at least one other keyword.

According to another embodiment, the method further comprises acts of accessing, over a computer network, allocation limit data for the second group of keywords; and determining, with reference to the allocation limit data, the second portion of the unspent amount to be allocated to the second group of keywords.

According to another embodiment, the act of generating bids for the first group of keywords includes selecting at least one keyword from the first group of keywords, accessing performance data and bid data for the at least one keyword, determining a relationship between the performance data and the bid data, estimating, based on the relationship, a performance of the at least one keyword, and estimating a clickthrough rate of the at least one keyword. According to a further embodiment, the act of accessing performance data and bid data for the at least one proxy search keyword comprises an act of accessing an impression count. According to another embodiment, the act of determining a relationship between the performance data and the bid data further comprises an act of multiplying the impression count by a click-through rate. According to a still further embodiment, the click-through rate is associated with at least one proxy search keyword.

According to another aspect, a system is provided. The system comprises a memory configured to store budget data and historical spend data. The system further comprises allocation engine comprising a first processor configured to determine a baseline portion of a budget to be allocated to a first group of keywords; a second processor configured to predict, with reference to the historical spend data and the budget data, an unspent amount; a third processor configured to calculate, based upon at least one allocation parameter, a first portion of the unspent amount to be allocated; a fourth processor configured to allocate the baseline portion and the first portion of the unspent amount to the first group of keywords; and a fifth processor configured to allocate a second portion of the unspent amount to the second group of keywords. The system further comprises a bid generation engine configured to generate bids for the first group of keywords.

According to still another aspect, a computer-readable medium comprises computer-executable instructions that, when executed on a processor of a server, perform a method comprising acts of a method for generating at least one keyword bid. The method comprises acts of accessing, over a computer network, budget data and historical spend data for at least two groups of keywords, and determining a baseline portion of a budget to be allocated to a first group of keywords. The method further comprises acts of predicting, with reference to the historical spend data and the budget data, an unspent amount; calculating, based upon at least one adjustable allocation parameter, a first portion of the unspent amount to be allocated, and allocating the baseline portion and the first portion of the unspent amount to the first group of keywords. The method further comprises acts of allocating a second portion of the unspent amount to the second group of keywords, and generating bids for the first group of keywords.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects of the present embodiments may be implemented;

FIG. 2 shows an example system for allocating unspent advertising budget in accordance with an embodiment;

FIG. 3 depicts a block diagram of an application programming interface (API) in accordance with an embodiment;

FIG. 4 illustrates a an example physical and logical diagram of the system of FIG. 2 in more detail;

FIG. 5 shows a block diagram of an exemplary user interface in accordance with an embodiment; and

FIG. 6 shows an example process for allocating unspent advertising budget in accordance with an embodiment.

### DETAILED DESCRIPTION

A method and system are provided for predicting or estimating an amount of a keyword advertising budget that will remain unspent at the end of a time period of interest. At least a portion of that unspent amount may then be allocated to at least one other keyword group based on an adjustable allocation parameter. A marketer may thus control the way that unspent budget amounts predicted to be unspent at the end of the time period can flow to other keywords, where they are more likely to be spent. This makes it more likely that the entire advertising budget for the time period is spent.

The allocation parameter may be a percentage, or it may be part of a rule-based allocation scheme. Keyword groups may be ranked based on one or more metric values, and an allocation parameter may be applied accordingly. For example, a higher percentage of the unspent amount may be allocated to keyword groups having a lower CPC metric. The allocation parameter may be adjustable, for example, by the user of a computer system.

One or more of these features may be implemented on one or more computer systems coupled by a network (e.g., the Internet). Example systems upon which various aspects are implemented, as well as exemplary methods performed by those systems, are discussed in more detail below. Exemplary user interfaces configured for use in connection with the systems and methods are also described.

The aspects disclosed herein are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to generating at least one keyword bid. However, such a system may also perform other functions. Moreover, the systems described herein may be configured to include or exclude any of the functions discussed herein. Thus, these systems are not limited to specific functions or sets of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

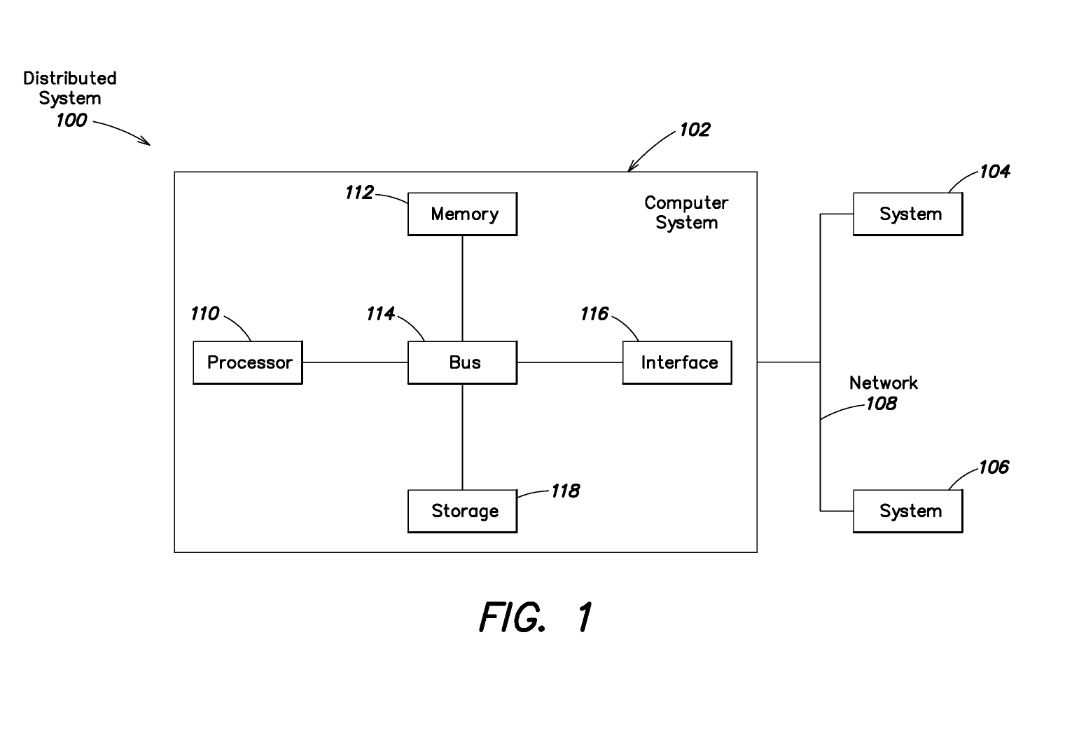

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA HOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 110 is connected to other system placements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device, such as flash memory or phase-change memory (PCM). Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system placements including specialized or standard computing bus technologies such as IDE, SCSI, PCI and InfiniBand. Thus, the bus 114 enables communications (for example, data and instructions) to be exchanged between system components of the computer system 102.

Computer system 102 also includes one or more interface devices 116 such as input devices, output devices and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

Storage system 118 may include a computer-readable and computer-writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having different architectures or components than that shown in FIG. 1. For instance, the computer system 102 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware placements included in computer system 102. A processor or controller, such as processor 110, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP) Similarly, functions in accord with aspects of the present invention may be implemented using an object-oriented programming language, such as SmallTalk, JAVA, C++, Ada, or C# (C-Sharp). Other object-programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing product, such as, for example, the Google search engine, the Yahoo search engine available from Yahoo! of Sunnyvale, Calif.; the Bing search engine available from Microsoft of Seattle Wash. Aspects of the system may be implemented on database management systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

In addition, the method described herein may be incorporated into other hardware and/or software products, such as a web publishing product, a web browser, or an internet marketing or search engine optimization tool.

Example System Architecture

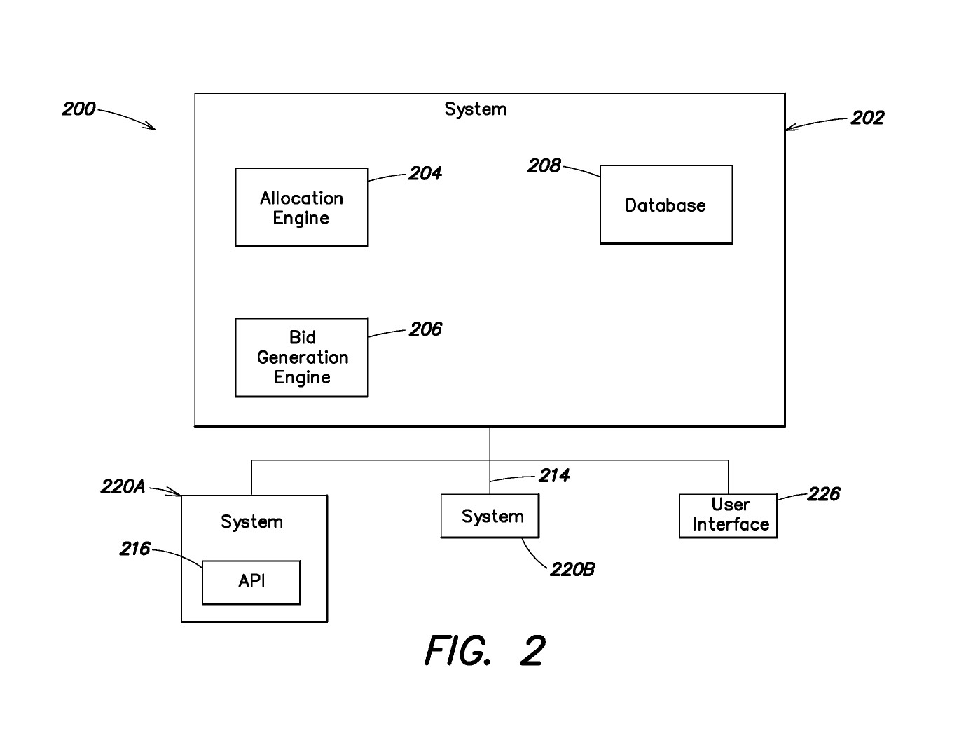

An example system in accordance with aspects of the invention can be seen in FIG. 2. The distributed system 200 may be used by or on behalf of a marketer interested in generating at least one keyword bid. As used herein, the term “marketer” may refer to either a user of the system 200, an entity on whose behalf the user is acting, or any entity associated with search engine marketing, without limitation.

The distributed system 200 includes a system 202. The system 202 may be a personal computer, a network appliance, a mainframe terminal, PDA, tablet computer, or any other computer system known in the art. The distributed system 200 includes a network interface 214 that may be configured to access keyword data over a computer network. The keyword data may include, for example, budget data and historical spend data. The system 202 includes an allocation engine 204, which is configured to determine a baseline portion of a budget to be allocated to a first group of keywords. The allocation engine 204 may also be configured to predict, with reference to the historical spend data and the budget data, an unspent amount based upon the comparison. The allocation engine 204 may also be configured to allocate the baseline portion and the portion of the unspent amount to the first group of keywords. The allocation engine 204 may also be configured to allocate the remainder of the unspent amount to the second group of keywords. The system 202 may also include a database 208, which may store the keyword data. The database 208 may also store one or more keywords for which information should be accessed and/or maintained. The system 202 may also include a bid generation engine 206, which may be configured to generate bids for the first group of keywords. The bids may be generated based on the allocation of the baseline portion and the portion of the unspent amount allocated to the first group of keywords.

In some embodiments, the bid generation engine 206 may also be configured to select at least one keyword from the first group of keywords, and access performance data and bid data for the at least one keyword. The performance data may include, for example, revenue data, advertising spend data, cost-of-goods sold data, click data, conversion data, and/or impression data. The bid generation engine 206 may also be configured to determine a relationship between the performance data and the bid data. The bid generation engine 206 may also be configured to estimate, based on the relationship, a performance of the at least one keyword, and to estimate a clickthrough rate of the at least one keyword.

The distributed system 200 may also include a user interface 226 for allowing the user to interact with the distributed system 200 and/or system 202.

The network interface 214 may be configured to allow the system 202 to access keyword data from other computer systems 220A and/or 220B over a computer network, for example, the Internet. The keyword data may include bid data, budget data, historical spend data, allocation limit data, revenue data, advertising spend data, cost-of-goods sold data, click data, conversion data, and/or impression data. Budget data may include an amount budgeted for a keyword group for a current or previous time period. Historical spend data may include an amount spent on advertising for a current or previous time period.

In some embodiments, the system 202 may be configured to access keyword data stored in a format such as CSV, XML, delimited file, flat text file, or other format. In other embodiments, the network interface 214 may access keyword data on the other system 220A through an Application Programming Interface (API) 216. The system 202 may be configured to store the keyword data in the database 208 or in another memory location so that it may be accessed at a later time.

In some embodiments, the other system 220A may be associated with or controlled by an entity that conducts keyword auctions, such as Google, Yahoo!, Bing, and Ask.com. The other system 220A may make keyword data available to be accessed through the network interface 214 for no charge, or may allow access for a per-access or subscription fee.

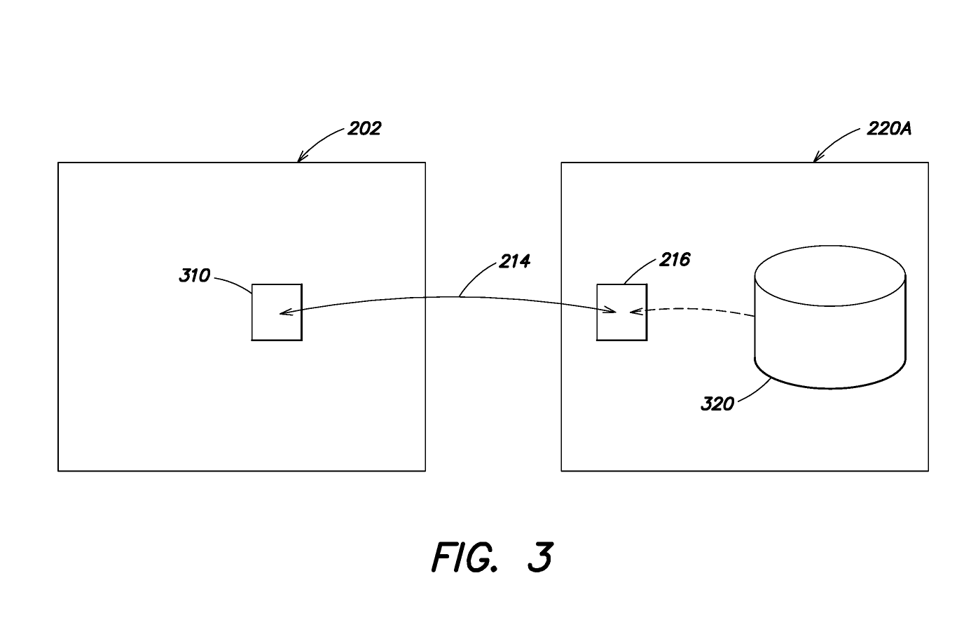

A block diagram showing an exemplary API 216 can be seen in FIG. 3. The API 216 may be an interface implemented by a software program on system 220A, thereby allowing the system 202 to interact with system 220A over the network interface 214. Software 310 that is configured to interact with the API 216 may be implemented on system 200. The API 216 and/or the software 310 may allow the system 202 to indirectly access information stored in a database 320 on the other system 220A. According to one embodiment, the API 216 may be implemented as a web service based on a protocol such as Simple Object Access Protocol (SOAP), or may be implemented on another architecture, such as a Representational State Transfer (REST) architecture. In some embodiments, the API 216 may interact with the Google AdWords API.

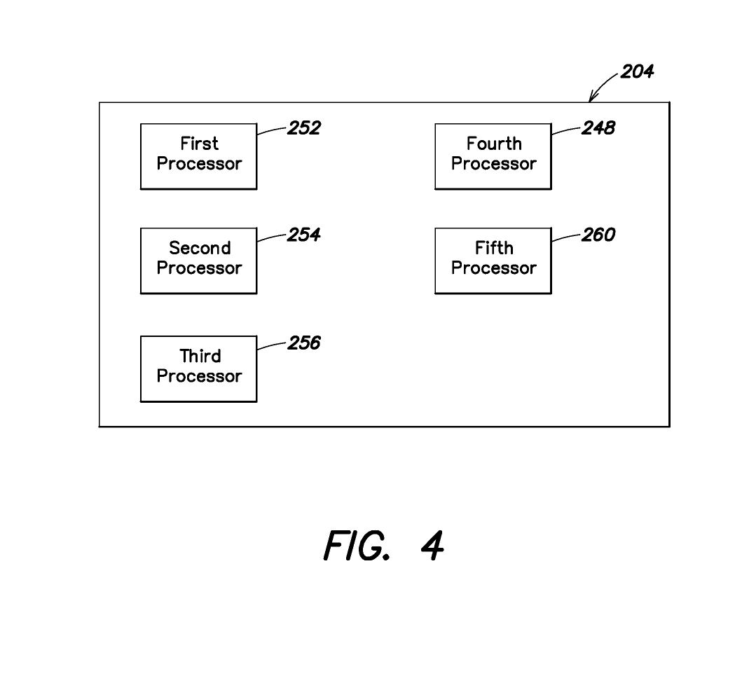

Referring to FIG. 4, the allocation engine 204 may comprise one or more processors configured to perform certain tasks. For example, a first processor 252 may be configured to determine a baseline portion of a budget to be allocated to a first group of keywords. The baseline portion may be determined by a number of techniques. For example, the baseline portion may be determined through a default setting of the system 202. In some embodiments, the baseline portion is provided by a user of the system 202. In some embodiments, the baseline portion is accessed through the API 216. The baseline portion may be determined through optimal bid generation techniques such as those described in U.S. patent application Ser. No. 13/181,603, entitled “System and Method for Generating a Keyword Bid,” herein incorporated by reference.

The allocation engine 204 may also comprise a second processor 254 configured to predict, with reference to the historical spend data and the budget data, an unspent amount. In some embodiments, the unspent amount may be predicted by comparing the historical spend data to the budget data to determine, for the first group of keywords, what amount of an advertising budget allocated to the group was not, in fact, spent during a particular earlier time period. In other embodiments, the historical spend data may correspond to a current time period, and may be compared to the budget data to determine what amount of the advertising budget allocated to the group has not yet been spent during the current time period.

According to one embodiment, the unspent amount may be predicted with reference to a comparison of budget data with historical spend data for an incomplete time period, such as a current time period. For example, if the budget data indicates that $1000 was allocated to the first keyword group for a current time period in which 50% of the time period has passed, and the historical spend data shows that only $425 of that amount was spent, then the unspent amount may be predicted to be $150 ([$1000−($425*(1/.5))]).

According to another embodiment, the unspent amount may be predicted with reference to a comparison of budget data with historical spend data from a complete time period, such as a previous time period. For example, if the budget data indicates that $1000 was allocated to the first keyword group, and the historical spend data shows that only $825 of that amount was spent during the complete time period, then the unspent amount for the current time period may be predicted to be $175, the same amount unspent in the previous time period.

The allocation engine 204 may also comprise a third processor 256 configured to calculate, based upon at least one allocation parameter, a first portion of the unspent amount to be allocated. In some embodiments, the at least one allocation parameter may include at least one percentage value, and the first portion of the unspent amount may be determined as a percentage of the unspent amount. In some embodiments, the at least one allocation parameter may be a percentage that varies based on the day of the month. For example, the at least one allocation parameter may increase for each day of the month, so that later in the month more of the unspent amount is allocated to the first portion.

In some embodiments, the at least one allocation parameter may be a percentage that varies based on the aggregate unspent budget for the at least two groups of keywords. This may be useful where it is desirable to adjust the proportional bid amounts for the first and second groups of keywords as the budget is spent. For example, the allocation engine 204 may be configured to apply a first percentage of the unspent amount to the first portion when the aggregate unspent budget is higher, but modify the first percentage to a second percentage as the budget is spent and the aggregate unspent budget decreases. In some embodiments, the first percentage may be greater than the second percentage. In other embodiments, the first percentage may be less than the second percentage. In still other embodiments, the first percentage may be substantially equal to the second percentage.

In other embodiments, the at least one allocation parameter may be a percentage that varies based on a relationship between a first average cost-per-click amount of the first group of keywords and a second average cost-per-click amount of at least one other group of keywords. This approach may be useful in allocating portions of the unspent budget in a manner that minimizes the average cost-per-click amount for each allocation. For example, if the first average cost-per-click amount is lower than the second average cost-per-click amount, it may be desirable for the allocation engine 204 to allocate a higher percentage of the unspent portion to the first group of keywords.

In some embodiments, the at least one allocation parameter may be a percentage that varies based on a relationship between a first average marginal cost-per-click of the first group of keywords and a second average marginal cost-per-click of at least one other group of keywords. This approach may be useful in allocating portions of the unspent budget in a manner that minimizes the marginal cost-per-click amount for each allocation. For example, if the first average marginal cost-per-click amount is lower than the second average marginal cost-per-click amount, it may be desirable for the allocation engine 204 to allocate a higher percentage of the unspent portion to the first group of keywords. In other embodiments, the allocation parameter may vary based on marginal cost-per-action relationships. In some embodiments, the action may be a conversion. In other embodiments, the allocation parameter may vary based on marginal ROAS relationships. In other embodiments, the allocation parameter may vary based on marginal ROI relationships. In some embodiments, the first and second average marginal cost-per-click may be calculated or updated before the allocation parameter is determined, and the allocation parameter may be adjusted accordingly.

In some embodiments, the at least one allocation parameter may vary based upon at least one spending multiplier. The at least one spending multiplier may be a numerical multiplier, percentage, or ratio that is applied to the at least one allocation parameter. For example, the at least one spending multiplier could be one or more numbers by which bids associated with the first keyword group are multiplied. This would allow a marketer additional control on the overall spending rate; if the marketer wants to reduce the risk of finishing the month with unspent budget, they could simply raise the at least one spending multiplier to ensure that spending is occurring across the board at a higher rate.

In some embodiments, the act of determining a baseline portion of the budget to be allocated to the first group of keywords may include determining an unspent amount previously allocated to at least one other keyword. For example, the baseline portion may include amounts previously allocated to another keyword. In this manner, unspent amounts may be allocated sequentially to a number of keywords until they are spent.

In some embodiments, the allocation engine 204 may be configured to access allocation limit data in order to determine a maximum amount that may be allocated to the second keyword group. It may be determined that the amount allocated to the second keyword group may not exceed some percentage or multiple of a baseline amount allocated to the second keyword group. In other embodiments, a value limit may be set for the amount allocated to the second keyword group.

Referring still to FIG. 4, the allocation engine 204 may comprise a fourth processor 258 configured to allocate the baseline portion and the first portion of the unspent amount to the first group of keywords. This aggregate amount may represent the baseline amount initially allocated to the first group of keywords according to bid generation techniques, plus an amount that, while it may remain unspent, is allocated to the first group of keywords nonetheless.

The allocation engine 204 may comprise a fifth processor 260 configured to allocate a second portion of the unspent amount to the second group of keywords.

Referring again to FIG. 2, the database 208 may be a relational database or any other method of storing data known in the art, such as XML, flat file, or spreadsheet, or other location in a computer memory. The database 208 may be a commercial database product, such as IBM DB2, Microsoft SQL Server, MySQL, Openbase, Sybase, or other database product. The database 208 may store textual information and/or binary information, and may store textual information as plain text, or may encode it in binary or other format.

The database 208 may be configured to store keyword data including budget data and historical spend data. The database 208 may also be configured to store performance data, and may also store metrics and other data derived from the performance data and bid amounts and other sources. Examples of such metrics include ROI, profit, impressions, clicks, conversions, advertising cost such as cost per click (CPC), cost of goods sold, and ROAS.

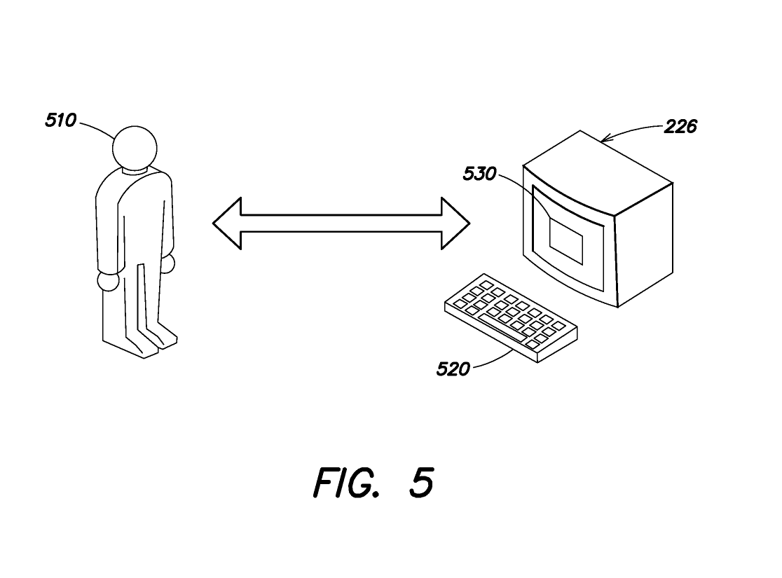

A block diagram illustrating an exemplary user interface can be seen in FIG. 5. The user interface 226 may allow a user 510 to interact with the user interface 226 through the use of a user input device 520. The user input device 520 may be of any type known in the art, such as a keyboard, mouse device, trackball, microphone, touch screen, printing device, or display screen. The user interface 226 may display an indication 530 in response to the input entered by the user 290. For example, the indication 530 may indicate whether the user input is valid.

The user interface 226 may allow the user 510 to select, input, vary, or adjust the allocation parameter. For example, the user interface 226 may allow for the selection or input of a numerical value, such as through a text box, slider, pull down menu, or other element for receiving input. In some embodiments, the user interface 226 may allow for the allocation parameter to be selected or adjusted graphically, for example, on a graph or chart. In other embodiments, the user interface 226 may allow for a rule-based scheme to be controlled. For example, the user interface 226 may allow the user 510 to enter one or more rules or conditions by which the allocation parameters are set.

### Exemplary Method

Having described various aspects of a system for generating keyword bid sets, the operation of such a system is now described.

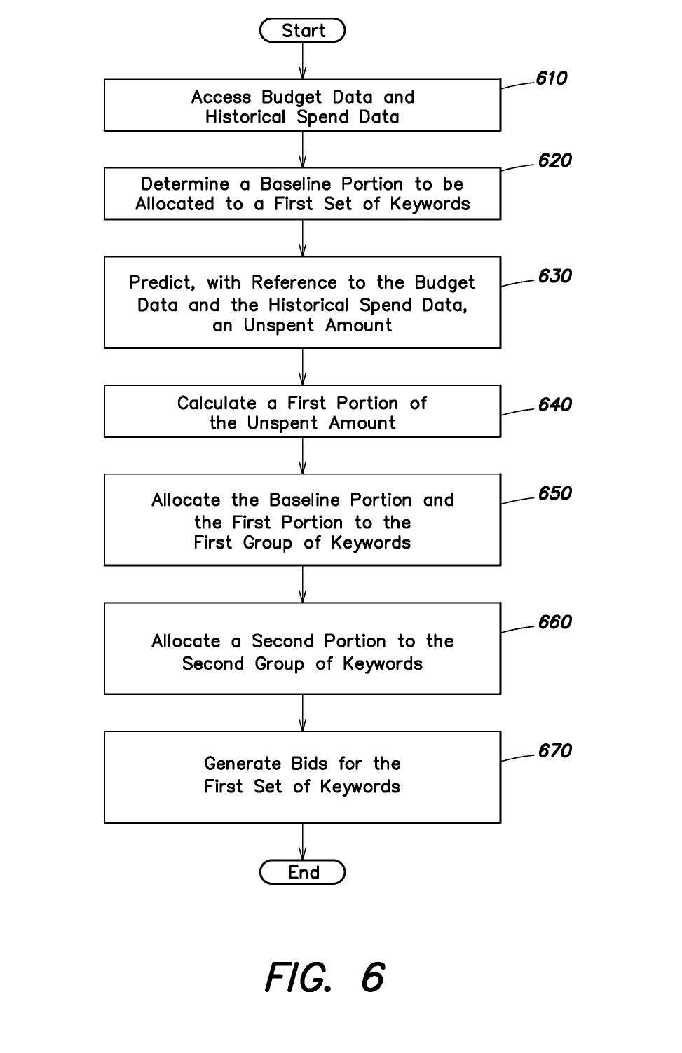

A method according to one embodiment is described with reference to FIG. 6. In some embodiments, the method may be embodied in a module, plugin, or component of a bid management system such as the AdMax™ online marketing platform offered by the Search Agency of Los Angeles, Calif. In other embodiments, the method may be embodied in a stand-alone application that performs the functions described herein.

In act 610, the system may access keyword data over a computer network. The keyword data may include bid data, budget data, and historical spend data. The keyword data may also include revenue data, cost-of-goods sold data, click data, conversion data, and/or impression data.

The budget data may include an amount currently budgeted for at least one keyword. In some embodiments, the budget data may represent a value previously allocated or budgeted to advertising for at least one keyword. In some embodiments, the historical budget data may represent the amount budgeted in the most recent relevant time period. In other embodiments, the historical budget data may represent an average amount budgeted over a number of time periods. In some embodiments, the average amount budgeted may be a weighted average, for example, with more recent time periods weighted more than less recent time periods.

The historical spend data may represent a value previously actually spent on advertising for at least one keyword. In some embodiments, the historical spend data may represent the amount spent in the most recent relevant time period. In other embodiments, the historical spend data may represent an average amount spent over a number of time periods. In some embodiments, the average amount spent may be a weighted average, for example, with more recent time periods weighted more than less recent time periods.

Referring still to act 610, performance data for a plurality of keyword bid amounts may be accessed over a computer network. In some embodiments, the performance data may be historical data, or may be estimated from or derived from historical data. For example, the performance data may include keyword-specific performance metrics for each of a number of bid amounts. This historical performance data may be specific to a particular marketer, or may be aggregated from the performance of multiple keywords for which bids were placed during a certain time period. In other embodiments, the performance data may be predicted or estimated values for metrics that have not yet been recorded or which were not recorded.

The performance data may include bid amounts as well as search marketing metrics known in the art, including impressions, clicks, conversions, profit, ROI, cost per click, ROAS, and others. An impression is an occurrence of a given advertisement being displayed to a user of a search engine. A click is an occurrence of a user of a search engine using a user interface device (e.g., a keyboard or a mouse) to click on or otherwise favorably interact with a given advertisement. CPC (cost-per-click) is the cost incurred or price paid by a marketer when a user clicks on an advertisement associated with the marketer. In some embodiments, the cost may represent, for example, a “pay-per-click” fee incurred by the marketer and payable to the search engine every time a user clicks on an advertisement associated with the marketer. In other embodiments, a “pay-per-impression” fee model may be used. In these embodiments, the cost-per-click can be calculated by determining the number of impressions required, on average, to generate a click (i.e., impressions per click), then multiplying that by the cost per impression to arrive at the cost per click.

In some embodiments, information may be accessed about sales or other transactions relating to the product or service that is the subject of one or more advertisements associated with the plurality of keywords. Such performance data may include, for example, the revenue from the transaction, the cost of goods sold (COGS), the advertising cost, and the profit from the transaction. In some embodiments, this data may be accessed through a data source such as a sales or accounting database.

In some embodiments, an initial or approximate keyword bid amount may be determined, and performance data may be accessed for the most similar bid amounts for which performance available. For example, if it is determined that the amount to be bid for a particular keyword will be approximately $1.00, then performance data that is available for bid amounts close to $1.00 (e.g., $0.96 and $1.02) may be accessed.

In some embodiments, all available performance data for a particular bid amount may be accessed. For example, the number of clicks received at a given bid amount by each advertisement associated with a particular keyword may be accessed. In other embodiments, summarized or partially summarized performance data may be accessed. For example, for a given keyword, only a total or average number of clicks received by an advertisement associated with the keyword over a given period of time may be accessed. Any type of statistical measure known in the art may be used, including the sum, count, mean, median, mode, or other measure.

As an example of accessing performance data for a plurality of keyword bid amounts, performance data may be accessed for a given keyword for bid amounts $5.00, $4.65, $3.00, $2.75, and $2.00. The performance data may include historical performance data for keywords and/or advertisements associated with the keyword, where the performance data corresponds to each of those bid amounts. For example, the cost of the advertisement, as well as the number of impressions and clicks for all advertisements associated with keywords may be accessed for one or more recent or historic bid amounts. An example of performance data corresponding to those bid amounts could be represented as follows:

| Bid | CPC | Clicks | Impressions |
|---|---|---|---|
| $5.00 | $4.00 | 842 | 7959 |
| $4.65 | $3.95 | 754 | 7193 |
| $3.00 | $2.84 | 302 | 6487 |
| $2.75 | $2.65 | 194 | 4939 |
| $2.00 | $1.45 | 120 | 3021 |

Referring still to act 610, the keyword data may be accessed over a computer network such as the Internet, and may be accessed using an Internet protocol known in the art, for example, HTTP, HTTPS, or FTP. In some embodiments, an API may be used to interact with remote data sources or databases. For example, an API may be used to access metrics relating to the Google AdWords keyword bidding program. In still other embodiments, the performance data may be accessed through the use of a scripting language such as PHP, CGI, or the like, or may be accessed through the use of a query language such as MySQL.

In some embodiments, the keyword data may be automatically accessed over the computer network at regularly scheduled intervals, for example, as part of a batch download process. In other embodiments, the access of keyword data may be may be triggered through a particular interaction by a user with a user interface, such as the user signaling the intent to generate a keyword bid set.

The keyword data may be accessed and/or stored in any number of formats, including XML, plain text, or any of a number of database formats such as IBM DB2, Microsoft SQL Server, MySQL, Openbase, Sybase, or other database format.

In act 620, a baseline portion of a budget to be allocated to a first group of keywords is determined. The baseline portion may be determined by any of a number of techniques. For example, the baseline portion may be determined through a default setting of the system 202, may be provided by a user of the system 202, or may be accessed through the API 216. The baseline portion may be determined through optimal bid generation techniques, for example, those described in U.S. patent application Ser. No. 13/181,603, entitled “System and Method for Generating a Keyword Bid.”

In act 630, an unspent amount is predicted with reference to the historical spend data and the budget data. This unspent amount may be predicted based on the difference between the budget data and the historical spend data. In some embodiments, the unspent amount for a current or future time period may be predicted to be equal to the difference between the budget data and the historical spend data.

In act 640, a first portion of the unspent amount to be allocated is calculated based upon at least one allocation parameter. In some embodiments, the at least one allocation parameter may be a percentage. For example, the at least one allocation parameter may be a percentage corresponding to a percentage of the unspent amount to be allocated to the first portion. The at least one allocation parameter may be a percentage that varies based upon the day of the month. For example, the at least one allocation parameter may increase for each day of the month, so that later in the month more of the unspent amount is allocated to the first portion.

In some embodiments, the at least one allocation parameter may be determined by a rule-based scheme. For example, the rule-based scheme may define certain criteria according to which the at least one allocation parameter may be set. In some embodiments, the rule-based scheme may indicate that the at least one allocation parameter should be determined based on a metric associated with the first keyword group. The metric may be calculated for the first keyword group and at least one other keyword group. For example, the metric may be ROI, profit, impressions, clicks, conversions, advertising cost such as cost per click (CPC), cost of goods sold, and ROAS. The keyword groups may be ranked according to the metric in ascending order, descending order, optimal value, or any other desired target or combination of targets, such as a multivariate score. For example, the keyword groups may be ranked in ascending order based upon a CPC metric. An allocation parameter may then be determined for one or more of the keyword groups based upon their relative rankings. For example, keyword groups having a metric within a certain range may be associated with one allocation parameter, and keyword groups having a metric within another range may be associated with a different parameter. For example, the keyword groups may be ranked in descending order based upon a budget metric. Metrics may be measured in absolute values, weighted values, scaled values, marginal values, or other adjusted value. For example, the keyword groups may be ranked in descending order based up on a marginal CPA metric. Metrics may be calculated using time-weightings, or other weightings. For example, the marginal CPA metric may be a weighted average, with more recent time periods weighted more than less recent time periods.

A budget metric may be any measure of the budgeted or actually spent amount for a keyword group for at least one current or previous time period. For example, the budget metric may be a percentage of the budget actually spent in one or more previous time period. Keyword groups, logically, that have previously performed well capable of spending most or all of their budget in previous time periods may be considered more reliable groups to allocate unspent budget to, to best ensure that the unspent budget will be spent.

In act 650, the baseline portion and the first portion of the unspent amount are allocated to the first group of keywords. For example, a bid value corresponding to the sum of the baseline portion and the first portion of the unspent amount may be assigned to first group of keywords.

In act 660, a second portion of the unspent amount is allocated to the second group of keywords. In some embodiments, the first and second portion of the unspent amount may total the entire unspent amount. In those embodiments, the second portion may correspond to the remainder of the unspent amount left after the first portion of the unspent amount is allocated to the first group of keywords in act 550. In other embodiments, the first and second portion of the unspent amount may total less than the entire unspent amount. In those embodiments, a portion of the unspent amount may remain after the first and second portions are allocated.

In act 670, bids may be generated for the first group of keywords. In some embodiments, the bids may correspond to the amount allocated to the first group of keywords in act 550. In other embodiments, the amount allocated to the first group of keywords in act 550 may be further adjusted.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim placements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A method for generating bids for a group of keywords, comprising acts of:
accessing budget data and historical spend data for bids for at least two groups of keywords through a network interface of a computer system;
determining a baseline portion of a budget to be allocated to bids for a first group of keywords utilizing an allocation engine of the computer system, the allocation engine including at least one processor;
predicting, with reference to the historical spend data and the budget data, utilizing the allocation engine of the computer system, an amount of the baseline portion of the budget to be allocated to the bids for the first group of keywords that will be unspent;
calculating, based upon at least one adjustable allocation parameter, a first portion of the unspent amount to be allocated utilizing the allocation engine of the computer system;
allocating the baseline portion and the first portion of the unspent amount to bids for the first group of keywords utilizing the allocation engine of the computer system;
allocating a second portion of the unspent amount to bids for the second group of keywords utilizing the allocation engine of the computer system; and
generating bids for the first group of keywords utilizing a bid generation engine of the computer system.

2. The method of claim 1, wherein the at least one allocation parameter is accessed over a computer network and the method further comprises an act of providing for a user of a computer system to adjust the adjustable allocation parameter.

3. The method of claim 1, wherein the at least one allocation parameter is a percentage.

4. The method of claim 3, wherein the at least one allocation parameter increases for each successive day of a month.

5. The method of claim 3, wherein the first portion of the unspent amount varies based upon one the aggregate unspent budget for the at least two groups of keywords;

6. The method of claim 3, wherein the portion of the unspent amount is determined based on one or more of:
a relationship between a first average cost-per-click amount of the first group of keywords and a second average cost-per-click amount of at least one other group of keywords;
a relationship between a first average marginal cost-per-click of the first group of keywords and a second average marginal cost-per-click of at least one other group of keywords;
a relationship between a first average marginal cost-per-action of the first group of keywords and a second average marginal cost-per-action of at least one other group of keywords;
a relationship between a first average marginal ROAS of the first group of keywords and a second average marginal ROAS of at least one other group of keywords; or
a relationship between a first average marginal ROI of the first group of keywords and a second average marginal ROI of at least one other group of keywords.

7. The method of claim 6, wherein the first average marginal cost-per-action is a first average marginal cost-per-conversion and the second average marginal cost-per-action is a second average marginal cost-per-conversion.

8. The method of claim 3, wherein the at least one allocation parameter is adjusted based upon at least one spending multiplier.

9. The method of claim 1, wherein the at least one allocation parameter is determined by a rule-based scheme and the method further comprises:
calculating at least one metric for the first keyword group and at least one other keyword group;
ranking the first keyword group and the at least one other keyword group relative to each other according to the at least one metric; and
determining an allocation parameter for the first keyword group based on its relative ranking.

10. The method of claim 9, wherein the at least one metric is a cost metric, and the first keyword group and the at least one other keyword group are ranked in ascending order based upon the at least one metric.

11. The method of claim 10, wherein the cost metric is one of a cost-per-click metric or a cost-per-action metric.

12. The method of claim 11, wherein the cost-per-action metric is a cost-per-conversion metric.

13. The method of claim 9, wherein the at least one metric is a budget metric, and the first keyword group and the at least one other keyword group are ranked in descending order based upon the budget metric.

14. The method of claim 13, wherein the budget metric is one of a budget amount metric or a percentage of a previously allocated budget spent in a time period.

15. The method of claim 9, wherein the at least one metric is a multivariate score, and the first keyword group and the at least one other keyword group are ranked in order based upon the multivariate score.

16. The method of claim 1, wherein the act of determining a baseline portion of a budget to be allocated to a first group of keywords comprises an act of determining an unspent amount previously allocated to at least one other keyword.

17. The method of claim 1, further comprising acts of:
accessing, over a computer network, allocation limit data for the second group of keywords; and
determining, with reference to the allocation limit data, the second portion of the unspent amount to be allocated to the second group of keywords.

18. A system comprising:
a memory configured to store budget data and historical spend data;
an allocation engine comprising:
a first processor configured to determine a baseline portion of a budget to be allocated to bids for a first group of keywords;
a second processor configured to predict, with reference to the historical spend data and the budget data, an amount of the baseline portion of the budget to be allocated to the bids for the first group of keywords that will be unspent;
a third processor configured to calculate, based upon at least one allocation parameter, a first portion of the unspent amount to be allocated;
a fourth processor configured to allocate the baseline portion and the first portion of the unspent amount to bids for the first group of keywords; and
a fifth processor configured to allocate a second portion of the unspent amount to bids for a second group of keywords; and
a bid generation engine configured to generate bids for the first group of keywords.

19. A non-transitory computer-readable medium comprising computer-executable instructions that, when executed on a processor of a computer, perform a method for generating at least one keyword bid, the method comprising:
accessing budget data and historical spend data for bids for at least two groups of keywords through a network interface of the computer;
determining a baseline portion of a budget to be allocated to bids for a first group of keywords utilizing an allocation engine of the computer, the allocation engine including at least one processor;
predicting, with reference to the historical spend data and the budget data, utilizing the allocation engine of the computer, an amount of the baseline portion of the budget to be allocated to the bids for the first group of keywords that will be unspent;
calculating, based upon at least one adjustable allocation parameter that decreases for each successive day of a month, a first portion of the unspent amount to be allocated utilizing the allocation engine of the computer system;
allocating the baseline portion and the first portion of the unspent amount to bids for the first group of keywords utilizing the allocation engine of the computer;
allocating a second portion of the unspent amount to bids for the second group of keywords utilizing the allocation engine of the computer; and
generating bids for the first group of keywords utilizing a bid generation engine of the computer.

20. The method of claim 1, wherein the budget data and historical spend data for bids for at least two groups of keywords is accessed through the network interface of the computer system from another computer system associated with an entity that conducts keyword auctions.
